(19) United States
(12) Patent Application Publication
(10) Pub. No.: US 2019/0279800 A1
(43) Pub. Date: Sep. 12, 2019

(54) MAGNETIC COMPOSITE AND ELECTRONIC COMPONENT USING THE SAME

(71) Applicant: Murata Manufacturing Co., Ltd., Kyoto-fu (JP)

(72) Inventor: Kenichi KATO, Nagaokakyo-shi (JP)

(73) Assignee: Murata Manufacturing Co., Ltd., Kyoto-fu (JP)

(21) Appl. No.: 16/264,228

(22) Filed: Jan. 31, 2019

(30) Foreign Application Priority Data
Mar. 9, 2018 (JP) 2018-042695

(51) Int. Cl. H01F 1/34; H01F 27/28; H01F 27/23; C04B 35/26; C04B 35/16; C04B 35/626; C04B 35/64

(52) U.S. Cl. CPC H01F 1/344; H01F 27/2804; H01F 27/23; C04B 35/26; H01F 27/365; C04B 35/62675; C04B 35/6261; C04B 35/64; H01F 2027/2809; C04B 35/16

(57) ABSTRACT

A magnetic composite contains a ferrite composition, zinc silicate, and borosilicate glass. The ferrite composition is composed of a spinel ferrite and bismuth oxide present in the spinel ferrite, and the percentage by weight of bismuth oxide to the whole magnetic composite is from about 0.024% by weight to about 0.23% by weight. The percentage by weight of zinc silicate based on the total weight of zinc silicate and the spinel ferrite is from about 8% by weight to about 76% by weight. The percentage by weight of borosilicate glass based on the total weight of zinc silicate and the spinel ferrite is from about 0.3% by weight to about 3% by weight.

### CROSS-REFERENCE TO RELATED APPLICATION

This application claims benefit of priority to Japanese Patent Application No. 2018-042695, filed Mar. 9, 2018, the entire content of which is incorporated herein by reference.

### BACKGROUND

### Technical Field

The present disclosure relates to a magnetic composite and an electronic component using the magnetic composite.

### Background Art

Magnetic composites, containing a magnetic material and a nonmagnetic material, have been used as materials for the body of multilayer coil components for removing high-frequency noise from an electronic device.

Japanese Unexamined Patent Application Publication No. 2016-196398 describes a composite ferrite composition containing a magnetic material and a nonmagnetic material. The magnetic material is a Ni—Cu—Zn ferrite, and the nonmagnetic material contains a low-dielectric-constant nonmagnetic material and bismuth oxide. The low-dielectric-constant nonmagnetic material is represented by the general formula (a(bZnO.cCuO).SiO_{2,} where a=1.5 to 2.4, b=0.85 to 0.98, and c=0.02 to 0.15 (and b+c=1.00). The mixing ratio between the magnetic material and the low-dielectric-constant nonmagnetic material is between 80% by weight:20% by weight and 10% by weight:90% by weight.

After research, the inventor found that electronic components produced with a magnetic composite rich in bismuth oxide as a sintering agent tend to be lower in electrical resistivity and prone to defects, such as unwanted spread of plating. With a magnetic composite rich in borosilicate glass, electronic components tend to be prone to glass migration to the surface of their outer electrodes, but with a low percentage of borosilicate glass, the electronic components are less reliable because of high water absorbency of their body, which is made of the magnetic composite.

### SUMMARY

Accordingly, the present disclosure provides a magnetic composite with which electronic components can be produced with high electrical resistivity, reduced glass migration to their outer electrodes, and low water absorbency. An electronic component using this magnetic composite is also provided.

The inventor found that when a magnetic composite contains borosilicate glass and a bismuth oxide-containing ferrite composition as a magnetic material and zinc silicate as nonmagnetic materials, setting the percentages of bismuth oxide and borosilicate glass within certain ranges provides electronic components with high electrical resistivity, reduced glass migration to their outer electrodes, and low water absorbency. Based on these findings, the inventor completed the present disclosure.

According to a first preferred embodiment of the present disclosure, a magnetic composite contains a ferrite composition, zinc silicate, and borosilicate glass. The ferrite composition is composed of a spinel ferrite and bismuth oxide present in the spinel ferrite, and the percentage by weight of bismuth oxide to the whole magnetic composite is about 0.024% by weight or more and about 0.23% by weight or less (i.e., from about 0.024% by weight to about 0.23% by weight). The percentage by weight of zinc silicate based on the total weight of zinc silicate and the spinel ferrite is about 8% by weight or more and about 76% by weight or less (i.e., from about 8% by weight to about 76% by weight). The percentage by weight of borosilicate glass based on the total weight of zinc silicate and the spinel ferrite is about 0.3% by weight or more and about 3% by weight or less (i.e., from about 0.3% by weight to about 3% by weight).

According to a second preferred embodiment of the present disclosure, an electronic component includes a body as a stack of a plurality of magnetic layers, outer electrodes on the outer surface of the body, a coil conductor inside the body, and extended conductors electrically coupling the outer electrodes and the coil conductor together. The body is made of the above magnetic composite.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view of an electronic component according to an embodiment of the present disclosure with the inside visible;

FIG. 2 is a perspective view of an electronic component according to another embodiment of the present disclosure with the inside visible;

FIG. 3 is a surface SEM image of an outer electrode of an electronic component fabricated using the magnetic composite of Comparative Example 5; and

FIG. 4 is a surface SEM image of an outer electrode of an electronic component fabricated using the magnetic composite of Example 5.

### DETAILED DESCRIPTION

The following describes embodiments of the present disclosure in detail with reference to the drawings. It is to be noted that the following embodiments are for illustration purposes and are not intended to limit the present disclosure.

Magnetic Composite

A magnetic composite according to an embodiment of the present disclosure is a composite material that contains a ferrite composition, zinc silicate (willemite), and borosilicate glass. The zinc silicate can be represented by a(bZn.cMO)SiO2, where a is about 1.5 or more and about 2.4 or less (i.e., from about 1.5 to about 2.4), b is about 0.85 or more and about 1 or less (i.e., from about 0.85 to about 1), and c is about 0.00 or more and about 0.15 or less (i.e., from about 0.00 to about 0.15). M can be Cu.

The ferrite composition is composed of a spinel ferrite and bismuth oxide (Bi₂O₃) present in the spinel ferrite. The spinel ferrite can be, for example, a Ni—Cu—Zn ferrite, a Mn—Cu—Zn ferrite, or a Ni—Mn—Cu—Zn ferrite. The spinel ferrite gives the magnetic composite good high-frequency characteristics. The chemical make-up of the spinel ferrite is not critical and can be selected as appropriate for the intended purpose. The spinel ferrite may contain one or more selected from Co, Mn, and Sn. Ni—Cu—Zn ferrites, by way of example, may each contain about 1 ppm or more and about 200 ppm or less (i.e., from about 1 ppm to about 200 ppm) of Co, about 1 ppm or more and about 3000 ppm or less (i.e., from about 1 ppm to about 3000 ppm) of Mn, and about 1 ppm or more and about 1000 ppm or less (i.e., from about 1 ppm to about 1000 ppm) of Sn. Mn—Cu—Zn and Ni—Mn—Cu—Zn ferrites may each contain about 1 ppm or more and about 200 ppm or less (i.e., from about 1 ppm to about 200 ppm) of Co and about 1 ppm or more and about 1000 ppm or less (i.e., from about 1 ppm to about 1000 ppm) of Sn.

The bismuth oxide works as a sintering agent, which helps sinter the magnetic composite. In a magnetic composite according to this embodiment, the bismuth oxide is present inside the spinel ferrite, more specifically in the boundaries between crystal grains of the ferrite. By virtue of being present inside the spinel ferrite, the bismuth oxide helps sinter the magnetic composite in a smaller amount. Besides the inside of the spinel ferrite, the magnetic composite may contain a trace amount of bismuth oxide on the surface of and outside the spinel ferrite. In this case, it is preferred that the percentage by weight of the bismuth oxide present inside the spinel ferrite based on the total weight of bismuth oxide in the magnetic composite be more than about 50% by weight.

The percentage by weight of bismuth oxide to the whole magnetic composite is about 0.024% by weight or more and about 0.23% by weight or less (i.e., from about 0.024% by weight to about 0.23% by weight), preferably 0.036% by weight or more and about 0.21% by weight or less (i.e., from about 0.036% by weight to about 0.21% by weight). When the percentage by weight of borosilicate glass based on the total weight of zinc silicate and the spinel ferrite is about 0.3% by weight or more, bismuth oxide present in an amount equal to or more than about 0.024% by weight, preferably equal to or more than about 0.036% by weight or more, will help sinter the magnetic composite. A weight percentage of bismuth oxide equal to or less than about 0.23% by weight, preferably equal to or less than about 0.21% by weight, will ensure a high resistivity of about 9 log Ω·cm or more.

The bismuth oxide content of the magnetic composite can instead be expressed as a percentage by weight of bismuth oxide to the spinel ferrite. In this case, the percentage by weight of bismuth oxide to the spinel ferrite is about 0.1% by weight or more and about 0.25% by weight or less (i.e., from about 0.1% by weight to about 0.25% by weight), preferably about 0.15% by weight or more and about 0.25% by weight or less (i.e., from about 0.15% by weight to about 0.25% by weight). A weight percentage of bismuth oxide within these ranges leads to improved sinterability of the magnetic composite and will ensure a high resistivity of about 9 log Ω·cm or more.

When the relative amounts of zinc silicate and the spinel ferrite are expressed as weight percentages, the percentage by weight of zinc silicate based on the total weight of zinc silicate and the spinel ferrite is about 8% by weight or more and about 76% by weight or less (i.e., from about 8% by weight to about 76% by weight). Too high a weight percentage of the nonmagnetic zinc silicate results in low magnetic permeability of the magnetic composite. Too low a weight percentage of zinc silicate results in poor characteristics under superimposed direct current (DC characteristics). Weight percentages of zinc silicate and the spinel ferrite satisfying the above condition will ensure high magnetic permeability combined with good DC characteristics.

The relative amounts of zinc silicate and the spinel ferrite can alternatively be expressed as volume percentages. In this case, the percentage by volume of zinc silicate based on the total volume of zinc silicate and the spinel ferrite is about 10% by volume or more and about 80% by volume or less (i.e., from about 10% by volume to about 80% by volume). Such volume percentages of zinc silicate and the spinel ferrite will ensure high magnetic permeability combined with good DC characteristics.

When the relative amounts of zinc silicate and the spinel ferrite are expressed as weight percentages, it is preferred that the percentage by weight of zinc silicate based on the total weight of zinc silicate and the spinel ferrite be about 8% by weight or more and about 25% by weight or less (i.e., from about 8% by weight to about 25% by weight). When the relative amounts of zinc silicate and the spinel ferrite are expressed as volume percentages, it is preferred that the percentage by volume of zinc silicate based on the total volume of zinc silicate and the spinel ferrite be about 10% by volume or more and about 30% by volume or less (i.e., from about 10% by volume to about 30% by volume). Such relative amounts of zinc silicate and the spinel ferrite will ensure a higher magnetic permeability of about 10 H/m or more.

The borosilicate glass works as a sintering agent, which help sinter the magnetic composite. The percentage by weight of borosilicate glass based on the total weight of zinc silicate and the spinel ferrite is about 0.3% by weight or more and about 3% by weight or less (i.e., from about 0.3% by weight to about 3% by weight). A weight percentage of borosilicate glass equal to or more than about 0.3% by weight leads to reduced water absorbency of the magnetic composite. A weight percentage of borosilicate glass equal to or less than about 3% by weight leads to reduced glass migration to the surface of the outer electrodes of an electronic component produced using the magnetic composite.

Preferably, the percentage by weight of borosilicate glass based on the total weight of zinc silicate and the spinel ferrite is about 1% by weight or more and about 3% by weight or less (i.e., from about 1% by weight to about 3% by weight). Such a weight percentage of borosilicate glass leads to even lower water absorbency of the magnetic composite, making the electronic components produced therewith more reliable.

The following describes the production of a magnetic composite according to this embodiment. It should be understood that the following is merely an example and not the only method for producing a magnetic composite according to this embodiment.

A spinel ferrite powder and bismuth oxide are weighed out and mixed to make the percentage by weight of bismuth oxide based on the weight of the spinel ferrite powder about 0.1% by weight or more and about 0.25% by weight or less (i.e., from about 0.1% by weight to about 0.25% by weight). The resulting mixture is calcined at temperatures between about 600° C. and about 800° C. The resulting ferrite composition powder and a zinc silicate powder are weighed out and mixed to make the percentage by weight of zinc silicate based on the total weight of zinc silicate and the spinel ferrite about 8% by weight or more and about 76% by weight or less (i.e., from about 8% by weight to about 76% by weight). Borosilicate glass is added to make the percentage by weight of borosilicate glass based on the total weight of zinc silicate and the spinel ferrite about 0.3% by weight or more and about 3% by weight or less (i.e., from about 0.3% by weight to about 3% by weight). The mixture is dispersed and milled with materials such as purified water, a dispersant, a binder, and/or a plasticizer, for example using a ball mill. The resulting slurry is shaped, for example by doctor blading, and the resulting compact is fired at temperatures between about 880° C. and about 930° C. This gives a magnetic composite according to this embodiment. The relative amounts of the raw-material spinel ferrite powder, bismuth oxide, zinc silicate oxide powder, and borosilicate glass are substantially the same as those of the spinel ferrite, bismuth oxide, zinc silicate, and borosilicate glass in the resulting magnetic composite.

Electronic Component

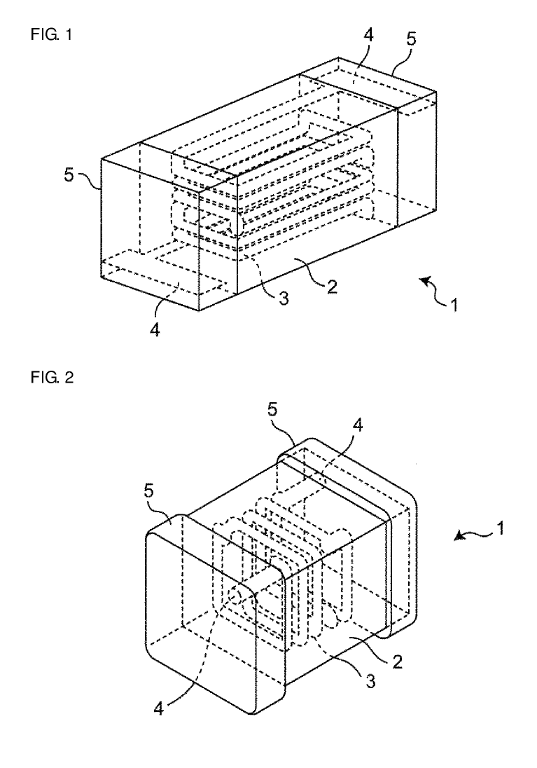

The following describes an electronic component according to an embodiment of the present disclosure. FIG. 1 illustrates an example of an electronic component according to this embodiment. The electronic component 1 in FIG. 1 is a multilayer coil component. The electronic component 1 according to this embodiment includes a body 2 as a stack of multiple magnetic layers, outer electrodes 5 on the outer surface of the body 2, a coil conductor 3 inside the body 2, and extended conductors 4 electrically coupling the outer electrodes 5 and the coil conductor 3 together. The body 2 is made of a magnetic composite according to an embodiment of the present disclosure. An electronic component according to this embodiment may have a structure as in FIG. 1, called vertical winding, or a structure as in FIG. 2, called horizontal winding. Electronic components according to this embodiment have high electrical resistivity, reduced glass migration to their outer electrodes, and low water absorbency.

The production of multilayer coil components as electronic components according to this embodiment is through, for example, the following process. First, a spinel ferrite powder and bismuth oxide are weighed out and mixed to make the percentage by weight of bismuth oxide based on the weight of the spinel ferrite powder about 0.1% by weight or more and about 0.25% by weight or less (i.e., from about 0.1% by weight to about 0.25% by weight). The resulting mixture is calcined at temperatures between about 600° C. and about 800° C. The resulting ferrite composition powder and a zinc silicate powder are weighed out and mixed to make the percentage by weight of zinc silicate based on the total weight of zinc silicate and the spinel ferrite about 8% by weight or more and about 76% by weight or less (i.e., from about 8% by weight to about 76% by weight). Borosilicate glass is added to make the percentage by weight of borosilicate glass based on the total weight of zinc silicate and the spinel ferrite about 0.3% by weight or more and about 3% by weight or less (i.e., from about 0.3% by weight to about 3% by weight). The mixture is dispersed and milled with materials such as purified water, a dispersant, a binder, and/or a plasticizer, for example using a ball mill. The resulting slurry is shaped, for example by doctor blading, into sheets of a predetermined thickness. These sheets are perforated with via holes at predetermined points by laser irradiation, and the via holes is filled with an electrically conductive paste. Then the electrically conductive paste is applied to the sheets by screen printing to form patterns for the coil conductor and extended conductors.

The sheets having conductor patterns are stacked in a predetermined order, and the stack is sandwiched from top and bottom between sheets having no conductor pattern. The stacked sheets are joined together by heat and pressure bonding, and the resulting structure is divided, for example with a dicer, into separate multilayer compacts. These multilayer compacts are fired at temperatures between about 880° C. and about 930° C. to give bodies with a coil conductor inside. An electrically conductive paste for outer electrodes is applied to the outer surface of these bodies and baked at about 900° C. to form outer electrodes, which may optionally be plated. In this way, electronic components according to this embodiment are obtained.

It is to be noted that the multilayer coil components illustrated in FIGS. 1 and 2 are not the only possible forms of electronic components according to this embodiment. An electronic component according to this embodiment may instead be, for example, a composite electronic component including a coil and another element, such as a capacitor. An example is an LC component.

### EXAMPLES

Samples of Examples 1 to 13 and Comparative Examples 1 to 12 were prepared as follows. First, a spinel ferrite powder and bismuth oxide were weighed out and mixed to make the percentage by weight of bismuth oxide based on the weight of the spinel ferrite powder as in Table 1. The resulting mixture was calcined at temperatures between about 600° C. and about 800° C. The resulting ferrite composition powder and a powder of a nonmagnetic material, specified in Table 1, were weighed out and mixed to make the percentage by weight of the nonmagnetic material powder based on the total weight of the nonmagnetic material powder and the spinel ferrite as in Table 1. Borosilicate glass was added to make the percentage by weight of borosilicate glass based on the total weight of the nonmagnetic material powder and the spinel ferrite as in Table 1. The mixture was dispersed and milled with materials such as purified water, a dispersant, a binder, and a plasticizer using a ball mill. The resulting slurry was shaped by doctor blading into a sheet about 50-μm thick. Substantially rectangular die-cuts of the sheet were stacked and joined together by pressure bonding into a multilayer block. Ring-shaped die-cuts of this multilayer block were fired at about 900° C. In this way, ring-shaped samples each measuring about 12 mm in inner diameter, about 20 mm in outer diameter, and about 1 mm in thickness were prepared.

TABLE 1

| | | | | Bi₂O₃ (% by weight) | | Borosilicate |
|---|---|---|---|---|---|---|
| | Nonmagnetic | Nonmagnetic material | | (to spinel | (to magnetic | glass |
| | material | (% by volume) | (% by weight) | ferrite) | composite) | (% by weight) |
| Comparative | Zinc silicate | 20 | 16 | 0 | 0 | 0 |
| Example 1 | | | | | | |
| Comparative | Zinc silicate | 20 | 16 | 0 | 0 | 3 |
| Example 2 | | | | | | |
| Example 1 | Zinc silicate | 20 | 16 | 0.1 | 0.084 | 0.3 |
| Example 2 | Zinc silicate | 20 | 16 | 0.1 | 0.084 | 3 |
| Comparative | Zinc silicate | 20 | 16 | 0.1 | 0.084 | 4 |
| Example 3 | | | | | | |
| Example 3 | Zinc silicate | 20 | 16 | 0.15 | 0.126 | 1 |
| Comparative | Zinc silicate | 20 | 16 | 0.25 | 0.210 | 0 |
| Example 4 | | | | | | |
| Example 4 | Zinc silicate | 20 | 16 | 0.25 | 0.210 | 0.3 |
| Example 5 | Zinc silicate | 20 | 16 | 0.25 | 0.210 | 3 |
| Comparative | Zinc silicate | 20 | 16 | 0.25 | 0.212 | 4 |
| Example 5 | | | | | | |
| Comparative | Zinc silicate | 20 | 16 | 0.35 | 0.294 | 0.3 |
| Example 6 | | | | | | |
| Comparative | Zinc silicate | 20 | 16 | 0.35 | 0.294 | 3 |
| Example 7 | | | | | | |
| Comparative | — | 0 | 0 | 0.15 | 0.150 | 1 |
| Example 8 | | | | | | |
| Example 6 | Zinc silicate | 10 | 8 | 0.15 | 0.138 | 1 |
| Example 7 | Zinc silicate | 20 | 16 | 0.15 | 0.126 | 1 |
| Example 8 | Zinc silicate | 30 | 25 | 0.15 | 0.113 | 1 |
| Example 9 | Zinc silicate | 40 | 34 | 0.15 | 0.099 | 1 |
| Example 10 | Zinc silicate | 50 | 44 | 0.15 | 0.084 | 1 |
| Example 11 | Zinc silicate | 60 | 54 | 0.15 | 0.069 | 1 |
| Example 12 | Zinc silicate | 70 | 64 | 0.15 | 0.054 | 1 |
| Example 13 | Zinc silicate | 80 | 76 | 0.15 | 0.036 | 1 |
| Comparative | Zinc silicate | 90 | 87 | 0.15 | 0.020 | 1 |
| Example 9 | | | | | | |
| Comparative | Aluminum oxide | 20 | 16 | 0.15 | 0.126 | 1 |
| Example 10 | | | | | | |
| Comparative | Silicon oxide | 20 | 16 | 0.15 | 0.126 | 1 |
| Example 11 | | | | | | |
| Comparative | Cordierite | 20 | 16 | 0.15 | 0.126 | 1 |
| Example 12 | | | | | | |

For each of Examples 1 to 13 and Comparative Examples 1 to 12, samples were tested as follows.

Relative Density

As a sinterability test, the relative density, defined as the percentage of measured as-sintered density to the theoretical as-sintered density, of a sample was determined from an as-sintered density measured by the method of Archimedes. The results are presented in Table 2.

Water Absorbency

Three samples were immersed in purified water for 30 minutes. The surface of removed samples was dried with a paper wiper, and the samples were weighed. The percentage change in weight from before to after immersion was calculated as a measure of water absorbency. The results are presented in Table 2.

Magnetic Permeability μ′

The magnetic permeability μ′ of five ring-shaped samples was measured using Agilent magnetic material test fixture (model number, 16454A) and impedance analyzer (model number, E4991A) at 10 MHz and averaged.

Characteristics Under Superimposed Direct Current

A wire was wound around a ring-shaped sample with 60 turns, and direct current was applied using Agilent 4284A LCR meter. The calculated applied magnetic field and permeability were monitored to determine the applied magnetic field at which there was a 10% decrease from the initial permeability. The results are presented in Table 2.

Electrical Resistivity

A disk-shaped sample 10 mm in diameter was coated on both sides with In—Ga. The resistance at 50 V was measured using Advantest R8340A resistance meter with probes on both sides of the sample, and the resistivity was calculated from the dimensions of the disk-shaped sample. The results are presented in Table 2.

Glass Migration

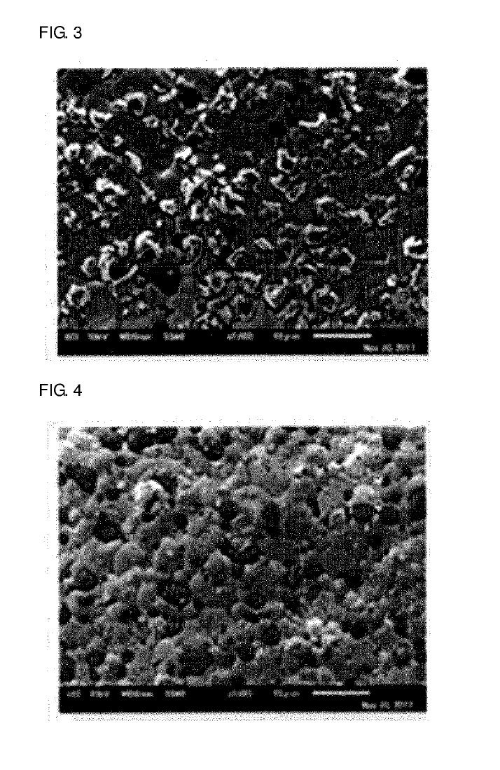

Sample electronic components were visually inspected for glass migration to the outer electrodes formed on their end faces. The results are presented in Table 2. FIGS. 3 and 4 are representative surface SEM (scanning electron microscope) images of an outer electrode of electronic components fabricated using the magnetic composites of Comparative Example 5 and Example 5, respectively.

TABLE 2

| | | | | | Elec- | |
|---|---|---|---|---|---|---|
| | | | | | trical | |
| | Rela- | Water | Magnetic | DC | resis- | |
| | tive | absor- | perme- | charac- | tivity | Glass |
| | density | bency | ability | teristics | (logΩ · | migra- |
| | (%) | (%) | (H/m) | (A/m) | cm) | tion |
| Comparative | 87.6 | 2.59 | 12.9 | 4450 | 8.2 | — |
| Example 1 | | | | | | |
| Comparative | 94.5 | 0.52 | 13.9 | 4014 | 8.8 | — |
| Example 2 | | | | | | |
| Example 1 | 95.0 | 0.46 | 14.0 | 3951 | 10.2 | No |
| Example 2 | 97.6 | 0.18 | 14.4 | 3764 | 9.4 | No |
| Comparative | 98.4 | 0.10 | 14.5 | 4083 | 9.2 | Yes |
| Example 3 | | | | | | |
| Example 3 | 97.6 | 0.10 | 14.3 | 3798 | 9.9 | No |
| Comparative | 94.8 | 0.51 | 13.9 | 3945 | 10.0 | — |
| Example 4 | | | | | | |
| Example 4 | 95.7 | 0.35 | 14.0 | 4080 | 10.4 | No |
| Example 5 | 98.3 | 0.12 | 14.4 | 3622 | 9.2 | No |
| Comparative | 99.1 | 0.04 | 14.6 | 4028 | 8.6 | Yes |
| Example 5 | | | | | | |
| Comparative | 96.8 | 0.25 | 14.2 | 4055 | 8.8 | No |
| Example 6 | | | | | | |
| Comparative | 98.3 | 0.03 | 14.5 | 3631 | 8.1 | No |
| Example 7 | | | | | | |
| Comparative | 98.7 | 0.08 | 74.5 | 517 | 10.3 | No |
| Example 8 | | | | | | |
| Example 6 | 98.2 | 0.05 | 19.5 | 2673 | 10.0 | No |
| Example 7 | 97.6 | 0.10 | 14.3 | 3798 | 9.9 | No |
| Example 8 | 97.8 | 0.10 | 10.3 | 5114 | 9.9 | No |
| Example 9 | 97.3 | 0.12 | 7.3 | 7011 | 10.1 | No |
| Example 10 | 95.9 | 0.37 | 5.2 | 10020 | 9.9 | No |
| Example 11 | 95.7 | 0.37 | 3.7 | 13046 | 9.9 | No |
| Example 12 | 95.4 | 0.42 | 2.6 | 15536 | 10.0 | No |
| Example 13 | 95.0 | 0.48 | 1.8 | 17959 | 9.9 | No |
| Comparative | 94.4 | 0.57 | 1.2 | 20029 | 9.9 | — |
| Example 9 | | | | | | |
| Comparative | 60.9 | 12.56 | 6.5 | 5196 | — | — |
| Example 10 | | | | | | |
| Comparative | 81.1 | 3.34 | 7.5 | 5069 | — | — |
| Example 11 | | | | | | |
| Comparative | 66.6 | 9.06 | 7.6 | 4657 | — | — |
| Example 12 | | | | | | |

In Comparative Example 1, the absence of bismuth oxide and borosilicate glass resulted in a low relative density (defined as about 95% or less; the same applies hereinafter), a high water absorbency (defined as about 0.5% or more; the same applies hereinafter), and a low resistivity (defined as about 9 log Ω·cm or less; the same applies hereinafter). In Comparative Example 2, the absence of bismuth oxide resulted in a low relative density, a high water absorbency, and a low resistivity. In Comparative Example 3, a weight percentage of borosilicate glass higher than about 3% by weight resulted in glass migration to the surface of outer electrodes. In Comparative Example 4, the absence of borosilicate glass resulted in a low relative density and a high water absorbency. In Comparative Example 5, a weight percentage of borosilicate glass higher than about 3% by weight resulted in a low resistivity and glass migration to the surface of outer electrodes. In Comparative Examples 6 and 7, a percentage by weight of bismuth oxide to the spinel ferrite higher than about 0.25% by weight resulted in a low resistivity. In Comparative Example 8, the absence of a nonmagnetic material resulted in poor DC characteristics. In Comparative Example 9, a weight percentage of zinc silicate higher than about 76% by weight resulted in a low relative density and a high water absorbency. In Comparative Example 10, replacing the nonmagnetic material zinc silicate with alumina (Al₂O₃) resulted in a low relative density and a high water absorbency. In Comparative Example 11, replacing the nonmagnetic material zinc silicate with silica (SiO₂) resulted in a low relative density and a high water absorbency. In Comparative Example 12, replacing the nonmagnetic material zinc silicate with cordierite (2MgO.2Al₂O₃.5SiO₂) resulted in a low relative density and a high water absorbency.

In Examples 1 to 13, samples had a high relative density and a low water absorbency compared with those in Comparative Examples 1 to 12. The DC characteristics were better than in Comparative Examples 1 to 12, and the resistivity was higher than about 9 log Ω·cm. Moreover, no glass migrated to the surface of outer electrodes in all of Examples 1 to 13.

The present disclosure includes, but is not limited to, the following aspects.

Aspect 1

A magnetic composite including a ferrite composition, zinc silicate, and borosilicate glass, wherein

the ferrite composition is composed of a spinel ferrite and bismuth oxide present in the spinel ferrite, and a percentage by weight of bismuth oxide to the whole magnetic composite is about 0.024% by weight or more and about 0.23% by weight or less (i.e., from about 0.024% by weight to about 0.23% by weight);

a percentage by weight of zinc silicate based on a total weight of zinc silicate and the spinel ferrite is about 8% by weight or more and about 76% by weight or less (i.e., from about 8% by weight to about 76% by weight); and

a percentage by weight of borosilicate glass based on the total weight of zinc silicate and the spinel ferrite is about 0.3% by weight or more and about 3% by weight or less (i.e., from about 0.3% by weight to about 3% by weight).

Aspect 2

The magnetic composite according to Aspect 1, wherein the percentage by weight of zinc silicate based on the total weight of zinc silicate and the spinel ferrite is about 8% by weight or more and about 25% by weight or less (i.e., from about 8% by weight to about 25% by weight).

Aspect 3

The magnetic composite according to Aspect 1 or 2, wherein the percentage by weight of borosilicate glass based on the total weight of zinc silicate and the spinel ferrite is about 1% by weight or more and about 3% by weight or less (i.e., from about 1% by weight to about 3% by weight).

Aspect 4

An electronic component including a body as a stack of a plurality of magnetic layers, outer electrodes on an outer surface of the body, a coil conductor inside the body, and extended conductors electrically coupling the outer electrodes and the coil conductor together, wherein the body is made of a magnetic composite according to any one of Aspects 1 to 3.

### INDUSTRIAL APPLICABILITY

Electronic components fabricated using a magnetic composite according to an embodiment of the present disclosure are highly reliable and will find a wide range of applications by virtue of their high electrical resistivity, reduced glass migration to their outer electrodes, and low water absorbency.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A magnetic composite comprising a ferrite composition, zinc silicate, and borosilicate glass, wherein:
the ferrite composition is composed of a spinel ferrite and bismuth oxide present in the spinel ferrite, and a percentage by weight of bismuth oxide to the whole magnetic composite is from about 0.024% by weight to about 0.23% by weight;
a percentage by weight of zinc silicate based on a total weight of zinc silicate and the spinel ferrite is from about 8% by weight to about 76% by weight; and
a percentage by weight of borosilicate glass based on the total weight of zinc silicate and the spinel ferrite is from about 0.3% by weight to about 3% by weight.

2. The magnetic composite according to claim 1, wherein the percentage by weight of zinc silicate based on the total weight of zinc silicate and the spinel ferrite is from about 8% by weight to about 25% by weight.

3. The magnetic composite according to claim 1, wherein the percentage by weight of borosilicate glass based on the total weight of zinc silicate and the spinel ferrite is from about 1% by weight to about 3% by weight.

4. An electronic component comprising a body as a stack of a plurality of magnetic layers, outer electrodes on an outer surface of the body, a coil conductor inside the body, and extended conductors electrically coupling the outer electrodes and the coil conductor together, wherein
the body is made of a magnetic composite according to claim 1.

5. The magnetic composite according to claim 2, wherein the percentage by weight of borosilicate glass based on the total weight of zinc silicate and the spinel ferrite is from about 1% by weight to about 3% by weight.

6. An electronic component comprising a body as a stack of a plurality of magnetic layers, outer electrodes on an outer surface of the body, a coil conductor inside the body, and extended conductors electrically coupling the outer electrodes and the coil conductor together, wherein
the body is made of a magnetic composite according to claim 2.

7. An electronic component comprising a body as a stack of a plurality of magnetic layers, outer electrodes on an outer surface of the body, a coil conductor inside the body, and extended conductors electrically coupling the outer electrodes and the coil conductor together, wherein
the body is made of a magnetic composite according to claim 3.

8. An electronic component comprising a body as a stack of a plurality of magnetic layers, outer electrodes on an outer surface of the body, a coil conductor inside the body, and extended conductors electrically coupling the outer electrodes and the coil conductor together, wherein
the body is made of a magnetic composite according to claim 5.
